(19) United States
(12) Patent Application Publication
(10) Pub. No.: US 2005/0031921 A1
(43) Pub. Date: Feb. 10, 2005

(54) Hybrid fuel cell

(76) Inventors: Stanford R. Ovshinsky, Bloomfield, MI (US); Srinivasan Venkatesan, Southfield, MI (US); Zdravko Menjak, Rochester Hills, MI (US); Boyko Aladjov, Rochester Hills, MI (US); Hong Wang, Troy, MI (US)

Correspondence Address: ENERGY CONVERSION DEVICES, INC., 2956 WATERVIEW DRIVE, ROCHESTER HILLS, MI, 48309, US

(21) Appl. No.: 10/772,011

(22) Filed: Feb. 4, 2004

Related U.S. Application Data
(63) Continuation-in-part of application No. 10/636,152, filed on Aug. 7, 2003.

(51) Int. Cl. H01M 8/18; H01M 4/58; H01M 4/96

(52) U.S. Cl. 429/21; 429/218.2; 429/44

(57) ABSTRACT

A hybrid fuel cell including at least one cathode, at least one anode, and at least one oxygen evolution electrode. The oxygen evolution electrode works in combination with the anode to produce hydrogen and/or oxygen as an electrolyzer while the anode and cathode work in combination to provide an electrical current as a fuel cell. The cathode and the oxygen evolution electrode may operate alone or in tandem during operation of the hybrid fuel cell.

### CROSS REFERENCE TO RELATED APPLICATIONS

The present invention is a continuation-in-part of, and is entitled to the benefit of the earlier filing date and priority of, co-pending U.S. patent application Ser. No. 10/636,152, which is assigned to the same assignee as the current application, entitled “A HYBRID FUEL CELL”, filed Aug. 7, 2003, the disclosure of which is hereby incorporated by reference.

### FIELD OF THE INVENTION

The present invention generally relates to fuel cells. More particularly, the present invention relates to fuel cells having a built-in electrolyzer designed to generate hydrogen and/or oxygen which is stored and supplied to the fuel cell as needed.

### BACKGROUND

As the world's population expands and its economy increases, the increase in the atmospheric concentrations of carbon dioxide is warming the earth causing climate changes. However, the global energy system is moving steadily away from the carbon-rich fuels whose combustion produces the harmful gas. Experts say atmospheric levels of carbon dioxide may be double that of the pre-industrial era by the end of the next century, but they also say the levels would be much higher except for a trend toward lower-carbon fuels that has been going on for more than 100 years. Furthermore, fossil fuels cause pollution and are a causative factor in the strategic military struggles between nations. Furthermore, fluctuating energy costs are a source of economic instability worldwide.

In the United States, it is estimated, that the trend toward lower-carbon fuels combined with greater energy efficiency has, since 1950, reduced by about half the amount of carbon spewed out for each unit of economic production. Thus, the decarbonization of the energy system is the single most important fact to emerge from the last 20 years of analysis of the system. It had been predicted that this evolution will produce a carbon-free energy system by the end of the 21^{st} century. The present invention is another product which is essential to shortening that period to a matter of years. In the near term, hydrogen will be used in fuel cells for cars, trucks and industrial plants, just as it already provides power for orbiting spacecraft. However, with the problems of storage and infrastructure solved (see U.S. application Ser. No. 09/444,810, entitled “A Hydrogen-based Ecosystem” filed on Nov. 22, 1999 for Ovshinsky, et al., which is herein incorporated by reference and U.S. patent application Ser. No. 09/435,497, entitled “High Storage Capacity Alloys Enabling a Hydrogen-based Ecosystem”, filed on Nov. 6, 1999 for Ovshinsky et al., which is herein incorporated by reference), hydrogen will also provide a general carbon-free fuel to cover all fuel needs.

Hydrogen is the “ultimate fuel.” In fact, it is considered to be “THE” fuel for the future. Hydrogen is the most plentiful element in the universe (over 95%). Hydrogen can provide an inexhaustible, clean source of energy for our planet which can be produced by various processes. Utilizing the inventions of subject assignee, the hydrogen can be stored and transported in solid state form in trucks, trains, boats, barges, etc. (see the '810 and '497 applications).

A fuel cell is an energy-conversion device that directly converts the energy of a supplied gas into an electric energy. Researchers have been actively studying fuel cells to utilize the fuel cell's potential high energy-generation efficiency. The base unit of the fuel cell is a cell having an oxygen electrode, a hydrogen electrode, and an appropriate electrolyte. Fuel cells have many potential applications such as supplying power for transportation vehicles, replacing steam turbines and power supply applications of all sorts. Despite their seeming simplicity, many problems have prevented the widespread usage of fuel cells.

Fuel cells, like batteries, operate by utilizing electrochemical reactions. Unlike a battery, in which chemical energy is stored within the cell, fuel cells generally are supplied with reactants from outside the cell. Barring failure of the electrodes, as long as the fuel, preferably hydrogen, and oxidant, typically air or oxygen, are supplied and the reaction products are removed, the cell continues to operate.

Fuel cells offer a number of important advantages over internal combustion engine or generator systems. These include relatively high efficiency, environmentally clean operation especially when utilizing hydrogen as a fuel, high reliability, few moving parts, and quiet operation. Fuel cells potentially are more efficient than other conventional power sources based upon the Carnot cycle.

The major components of a typical fuel cell are the hydrogen electrode for hydrogen oxidation and the oxygen electrode for oxygen reduction, both being positioned in a cell containing an electrolyte (such as an alkaline electrolytic solution). Typically, the reactants, such as hydrogen and oxygen, are respectively fed through a porous hydrogen electrode and oxygen electrode and brought into surface contact with the electrolyte. The particular materials utilized for the hydrogen electrode and oxygen electrode are important since they must act as efficient catalysts for the reactions taking place.

In a hydrogen-oxygen alkaline fuel cell, the reaction at the hydrogen electrode occurs between hydrogen fuel and hydroxyl ions (OH⁻) present in the electrolyte, which react to form water and release electrons:
H₂+2OH⁻→2H₂O+2e⁻.
At the oxygen electrode, oxygen, water, and electrons react in the presence of the oxygen electrode catalyst to reduce the oxygen and form hydroxyl ions (OH⁻):
O₂+2H₂O+4e⁻→4OH⁻.
The flow of electrons is utilized to provide electrical energy for a load externally connected to the hydrogen and oxygen electrodes.

The catalyst in the hydrogen electrode of the alkaline fuel cell has to not only split molecular hydrogen to atomic hydrogen, but also oxidize the atomic hydrogen to release electrons. The overall reaction can be seen as (where M is the catalyst):
M+H₂→2MH→M+2H⁺+2e⁻.
Thus the hydrogen electrode catalyst must efficiently dissociate molecular hydrogen into atomic hydrogen. Using conventional hydrogen electrode material with noble metal catalysts, the dissociated hydrogen atoms being transitional can easily recombine to form molecular hydrogen if they are not used very quickly in the oxidation reaction.

At the cathode, oxygen, water, and electrons react in the presence of the oxygen electrode catalyst to reduce the oxygen and form hydroxyl ions (OH⁻):
O₂+2H₂O+4e⁻→4OH⁻.
The flow of electrons is utilized to provide electrical energy for a load externally connected to the hydrogen and oxygen electrodes.

Electrolysis is the decomposition of water in an electrolyte environment into hydrogen and oxygen by use of an electrical current. The electrolytic decomposition of water in an alkaline electrolyte has long been practiced for the production of hydrogen and oxygen.

The major components of an electrolytic cell usually includes an anode and a cathode in contact with an electrolyte and a membrane used to separate the anode, the cathode, and the reaction products. During operation, a fixed current is applied across the anode and cathode while the anode and cathode are in contact with the electrolyte. Electrochemical reactions taking place at the anode and cathode form oxygen and hydrogen gas, respectively. The reactions and the overall reaction are represented as:
Cathode: 2H₂0+2e⁻→H₂+2OH⁻
Anode: 2OH⁻→½O₂+2e⁻+H₂0
Overall: H₂0→H₂+½O₂

The particular materials used for the anode and the cathode are important since they provide the necessary catalysts for the reactions taking place at the anode and cathode. For example, the role the anode catalyst M is believed to play in evolving oxygen in an electrolytic cell is as follows:
M+OH⁻→MOH+e⁻
MOH+OH—→MO+H₂O+e⁻
2MO→MO₂+M
MO₂→O2+M

In addition to allowing the desired reactions to take place, the catalytic efficiency of the catalytic materials is a very important consideration since an effective catalytic material reduces the operating energy requirements of the cell. The applied voltage necessary to produce the anode and cathode reactions in an electrolytic cell is the sum of the decomposition voltage (thermodynamic potential) of the compounds in the electrolyte being electrolyzed, the voltage required to overcome the resistance of the electrolyte and the electrical connectors of the cell, and the voltage required to overcome the resistance to the passage of current at the surface of the anode and cathode (charge transfer resistance). The charge transfer resistance is referred to as the overvoltage. The overvoltage represents an undesirable energy loss which adds to the operating costs of the electrolytic cell.

Electrolysis has proven to be particularly useful to produce the reactants, oxygen and hydrogen, as used by fuel cells to produce electricity. Electrolytic cells are frequently used in conjunction with fuel cells to provide fuel cells with the reactants needed to produce electricity. Electrolytic cells are typically used in conjunction with fuel cells to power satellites or provide power to other space applications. In such case, the electrolytic cell typically acquires the power needed by the electrolytic cell from solar energy. Solar energy is used by the electrolytic cell to produce hydrogen and oxygen which are used by the fuel cell to produce electricity used to power the desired application. Excess hydrogen and/or oxygen is usually produced and stored to allow for operation of the fuel cell during times when solar power is not available (eclipse periods).

While the utilization of an electrolytic cell working in conjunction with a fuel cell has many advantages for various applications, such systems still have many disadvantages. The disadvantages include increased weight, space, terminals, inter cell connects, cost, maintenance, etc. Improvements in these areas will help fuel cells to become the standard source of power for vehicles and many other applications.

### SUMMARY OF THE INVENTION

The present invention discloses a hybrid fuel cell comprising a fuel cell portion, an electrolytic cell portion, whereby the fuel cell portion and the electrolytic cell portion are adapted to operate alone or in tandem. The hybrid fuel cell further comprises an anode section including one or more anodes. The anode section may be shared between the fuel cell portion and the electrolytic cell portion. The anode may comprise a hydrogen storage material and/or Raney nickel whereby the anode comprises 0.0 to 88.0 weight percent of the hydrogen storage material, 0.0 to 88.0 weight percent Raney nickel, 4.0 to 12.0 weight percent of a binder material, and 0.0 to 5.0 weight percent of a conductive material. The conductive material may comprise graphite or graphitized carbon. The hydrogen storage material included in the anode may comprise Rare-earth metal alloys, Misch metal alloys, zirconium alloys, titanium alloys, magnesium/nickel alloys, or mixtures thereof.

The fuel cell portion comprises at least one cathode in electrical communication with the anode section. The cathode comprises a carbon matrix with an active catalyst material catalytic toward the dissociation of molecular oxygen dispersed therein. The active catalyst material may be selected from silver, silver alloys, silver oxide, cobalt, cobalt oxide, cobalt manganese oxide, nickel, manganese oxide, manganese dioxide, pyrolyzed macrocyclics, or combinations thereof. The cathode may further comprise a peroxide decomposing material.

The electrolytic cell portion comprises at least one oxygen evolution electrode in electrical communication with the anode section. The oxygen evolution electrode may comprise an electrocatalytic material deposited on a substrate. The electrocatalytic material may comprise a host matrix and at least one modifier element disposed therein. The host matrix comprises at least one transition metal element. The at least one modifier element may be selected from Co, Ni, Sr, Li, K, In, Sn, C, Mn, Ru, Zn, Al, and combinations thereof. The electrocatalytic material may also comprise Ti and Ru. The electrocatalytic material is preferably deposited on the substrate via sputtering, vapor deposition, electro-deposition, thermal spraying, plasma deposition, or spraying.

The electrolytic cell portion is adapted to accept an electrical current from a source of power external to said hybrid fuel cell. The fuel cell portion and the electrolytic cell portion may share an electrolyte. The hybrid fuel cell/electrolyzer may further comprise a hydrogen storage unit adapted to store hydrogen in gaseous, liquid, or metal hydride form, and/or an oxygen storage unit adapted to store oxygen in gaseous, liquid, or oxide form.

### BRIEF DESCRIPTION OF THE DRAWINGS

FIG. 1, shows an embodiment of a hybrid fuel cell/electrolytic cell in accordance with the present invention.

FIG. 2, shows an exploded view of the hybrid fuel cell/electrolytic cell depicted in FIG. 1.

### DETAILED DESCRIPTION OF THE PREFERRED EMBODIMENTS OF THE INVENTION

The present invention discloses a hybrid fuel cell with an insitu electrolytic cell. The hybrid fuel cell/electrolyzer can operate in 1) a fuel cell mode, 2) an electrolyzer mode, and 3) a hybrid mode which operates as a combined fuel cell/electrolytic cell. The hybrid fuel cell in accordance with the present invention provides for power generation via a fuel cell with the capability of producing hydrogen and oxygen for the fuel cell with a built-in electrolytic cell. The hybrid fuel cell may also work solely as an electrolytic cell to produce hydrogen and oxygen which may be stored for later use in the fuel cell.

The hybrid fuel cell generally comprises one or more electrochemical cell units connected in series. The number of electrochemical cell units within the hybrid fuel cell may be varied as needed to provide the desired power output. Each electrochemical cell unit includes a fuel cell portion and an electrolytic cell portion. The fuel cell portion includes at least one cathode, and the electrolytic cell portion includes at least one oxygen evolution electrode. The fuel cell portion and the electrolytic cell portion share a common anode section including at least one anode. The cathode in the fuel cell portion and the anode in the anode section work together as a fuel cell, while the oxygen evolution electrode in the electrolytic cell portion and the anode in the anode section work together as an electrolytic cell. In addition, the cathode in the fuel cell portion and the oxygen evolution electrode in the electrolytic cell portion may work together with the anode section simultaneously in “hybrid mode” whereby the hydrogen and/or oxygen produced by the electrolytic cell portion is fed directly to the fuel cell portion and/or stored. The anodes, cathodes, and oxygen evolution electrodes are in contact with an electrolyte. The electrolyte in the fuel cell portion may be in liquid, gel, molten, or solid form. The electrolyte in the electrolytic cell portion is in aqueous liquid form to allow for the production of hydrogen and oxygen. The fuel cell portion and the electrolytic cell portion may also share a common aqueous electrolyte.

The anodes, cathodes, and oxygen evolution electrodes may be disposed within frames in the electrochemical cell units. The frames provide pathways for oxygen, hydrogen, and/or electrolyte to contact the electrodes. The frames may be constructed from any material resistant to the environment within the electrochemical cell units. Examples of framed electrodes can be found in U.S. patent application Ser. No. 10/284,817, entitled “Fuel Cell With Overmolded Electrode Assemblies”, filed on Oct. 31, 2002 for Puttaiah et al., the disclosure of which is herein incorporated by reference.

The electrolytic portion of the hybrid fuel cell in accordance with the present invention is able to accept energy to produce hydrogen and/or oxygen in the electrolytic cell portion. The source of power may be supplied from regenerative braking, solar power, batteries, or other power supplies. Upon production, the hydrogen and oxygen may be directly fed to the fuel cell portion and/or may be stored for later use in the fuel cell portion. The hydrogen may be stored in hydride form in the anode or may be collected and stored in a hydrogen storage unit which stores hydrogen in gaseous, liquid, or hydride form. The oxygen may be stored in a oxygen storage unit which may store the oxygen in gaseous, liquid, or oxide form.

During normal operation, the anode section and cathode in the fuel cell portion work together and function like a fuel cell. The anode section is able to work with the cathode in the fuel cell portion as a fuel cell while working with the oxygen evolution electrode in the electrolytic cell portion thereby producing hydrogen and/or oxygen which may be stored or fed to the respective electrodes of the fuel cell portion. The electrolytic cell portion may also work alone with the anode section to produce hydrogen and/or oxygen which is then stored for later use in the fuel cell portion.

The fuel cell portion of the electrochemical cell units in accordance with the present invention may be designed to operate as an hydrogen-oxygen alkaline fuel cell, a PEM fuel cell, or a phosphoric acid fuel cell. These types of fuel cells use hydrogen and oxygen as reactants and are complimented by the inclusion of the electrochemical cell portion. Preferably, the fuel cell portion of the electrochemical cell units operate as a hydrogen-oxygen alkaline fuel cell.

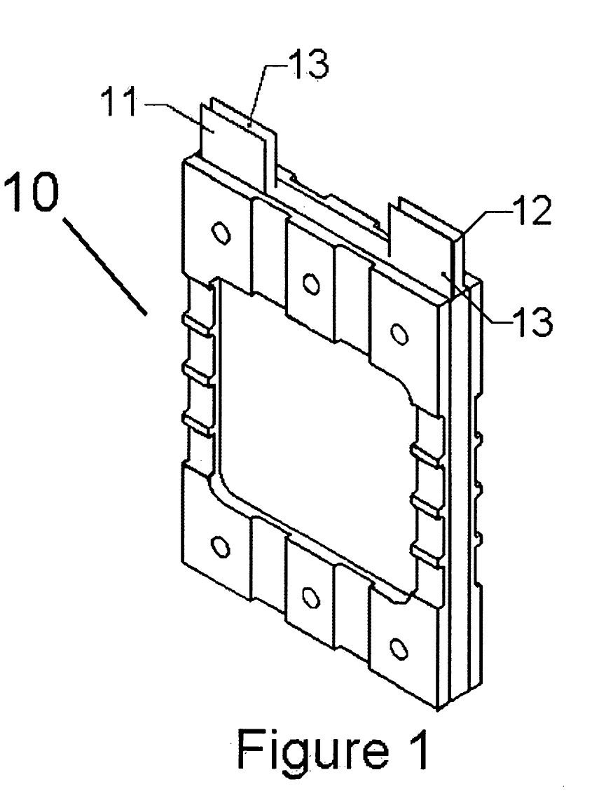

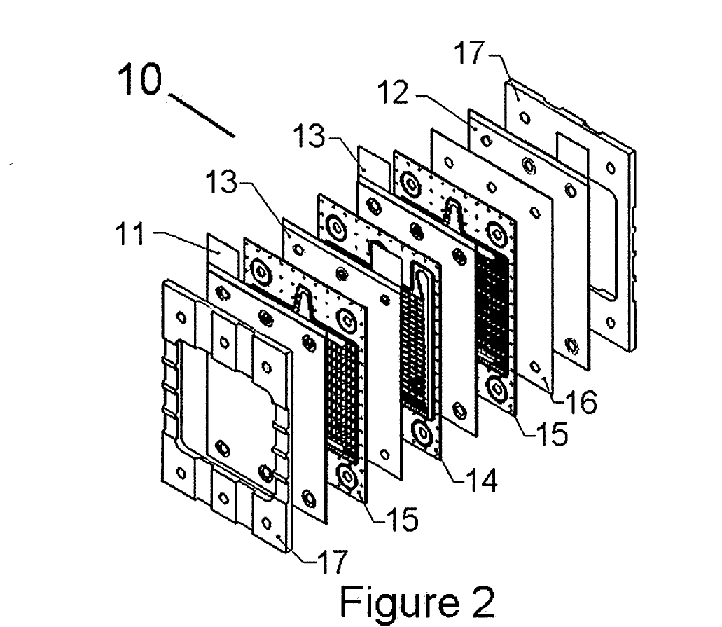

An embodiment of an electrochemical cell unit 10 in accordance with the present invention is shown in FIG. 1 and FIG. 2. The electrochemical cell unit operates as a hybrid hydrogen-oxygen alkaline fuel cell/electrolytic cell. The electrochemical cell unit includes a fuel cell portion including one cathode 11 having an oxygen interface and an electrolyte interface, and an electrolytic cell portion including one oxygen evolution electrode 12. The fuel cell portion and the electrolytic cell portion share an anode section including two anodes 13 each having a hydrogen interface and an electrolyte interface. Oxygen or an oxygen containing stream is supplied to the oxygen interface of the cathode 11 in the fuel cell portion and hydrogen is supplied to the hydrogen interface of the anodes 13 in the anode section. Hydrogen enters or is absorbed by the anodes 13 through the hydrogen interface. Hydrogen absorbed by the anode used in the fuel cell portion reacts with the electrolyte at the electrolyte interface of the anode to form water and electrons. Oxygen enters the oxygen interface of the cathode 11 in the fuel cell portion, is dissociated into atomic oxygen, and reacts electrochemically to form hydroxyl ions at the electrolyte interface of the cathode 11. The electrons flowing from the anode to the cathode form the electrical current supplied to the desired application. Upon applying a current across the electrolytic portion, the oxygen evolution electrode. 12 contained in the electrolytic cell portion works with the anode 13 adjacent to the oxygen evolution electrode 12 in the anode section to produce hydrogen and/or oxygen which may be directly supplied to the fuel cell portion and/or stored for later use.

The anodes 13 and cathodes 11 may be designed such that oxygen or hydrogen enters through the edge of the electrode and flows through the electrode, or each electrode may have an oxygen or hydrogen contacting side and an electrolyte contacting side. The electrolyte interfaces of the electrodes are in constant contact with an electrolyte. When the electrodes have an oxygen or hydrogen interface on one side of the electrode and an electrolyte interface on the opposing side of the electrode, the electrochemical cell should be designed such that the hydrogen or oxygen interfaces of the electrodes remain dry and unexposed to the electrolyte.

To optimize the flow of hydrogen, two anodes may be used in the anode section of electrochemical cell unit. When using two anodes, the anodes may be placed side by side with the hydrogen contacting surfaces of the anodes facing each other forming a hydrogen chamber between the hydrogen contacting surfaces of the anodes. A hydrogen distribution plate 14 may be placed between the anodes 13 in the hydrogen chamber to aid in the distribution of hydrogen across the hydrogen contacting surfaces of the anodes. The anode compositions may differ depending upon whether they are designed to operate as the anode of the fuel cell portion or the anode of the electrolytic cell portion. A stream of hydrogen is supplied between the anodes thereby providing hydrogen to the hydrogen contacting sides of the anodes. The cathode 11 is placed across from the electrolyte contacting side of one of the anodes, while the oxygen evolution electrode 12 is placed across from the electrolyte contacting side of the other anode 13. Electrolyte distribution plates 15 may be placed adjacent to the anodes and cathodes to aid in the distribution of electrolyte, hydrogen, or oxygen to the electrodes. A gas impermeable membrane 16 is placed between the oxygen evolution electrode 12 and anode section to prevent the evolved oxygen gas from oxidizing the anode. An example of a gas impermeable membrane that may be used in accordance with the present invention is Nafion™ (Trademark of DuPont). Microporous polypropylene based membranes may also be used. The electrolyte distribution plates 15 and/or gas impermeable membranes 16 may also provide mechanical support within the electrochemical cell unit 10. End plates 17 are typically placed at the ends of each electrochemical cell unit 10. The endplates 17 may be designed such that oxygen is allowed to contact the cathode 11 through the end plate 17. The endplates 17 are designed to provide support to each electrochemical cell unit 10.

Anodes as used in the hybrid hydrogen-oxygen alkaline fuel cell embodiment of the present invention are generally comprised of an active material supported on a substrate. The active material for the anode of the hybrid hydrogen-oxygen alkaline fuel cell may be generally comprised of 0.0 to 88.0 weight percent of a hydrogen storage material, 0.0 to 88.0 weight percent Raney Nickel, 4.0 to 12 weight percent binder material, and 0.0 to 5.0 weight percent graphite or graphitized carbon. The hydrogen storage material may be selected from Rare-earth metal alloys, Misch metal alloys, zirconium alloys, titanium alloys, magnesium/nickel alloys, and mixtures or alloys thereof which may be AB, AB₂, or AB₅ type alloys. Such alloys may include modifier elements to increase their hydrogen storage capability.

The binder materials may be any material, which binds the active material together to prevent degradation or disintegration of the electrode/electrode materials during the lifetime of the electrodes. Binder materials should be resistant to the environment present within the electrochemical cell units. This includes high concentration of KOH, dissolved oxygen, dissolved peroxyl ions (HO₂⁻), etc. Examples of additional binder materials, which may be added to the active composition, include, but are not limited to, polymeric binders such as polyvinyl alcohol (PVA), carboxymethyl cellulose (CMC) and hydroxycarboxymethyl cellulose (HCMC). Other examples of polymeric binders include fluoropolymers. An example of a fluoropolymer is polytetrafluoroethylene (PTFE). Other examples of additional binder materials, which may be added to the active composition, include elastomeric polymers such as styrene-butadiene. In addition, depending upon the application, additional hydrophobic materials and/or electroconductive plastics may also be added to the active composition. An example of an electroconductive polymeric binder material is commercially sold under the name Panipol.

Cathodes as used in hydrogen-oxygen alkaline fuel cell portion are typically comprised of a carbon matrix with a material catalytic toward the dissociation of molecular oxygen into atomic oxygen dispersed therein. Such cathodes may be single or multilayered. A single layered cathode may be comprised of a carbon matrix with an active catalytic material dispersed therein, with the carbon matrix being supported by at least one substrate. A multilayered cathode may be composed of an active material layer having a built-in hydrophobic character, a gas diffusion layer having a greater built-in hydrophobic character than the active material layer, and at least one substrate. The active material layer and the gas diffusion layer are positioned adjacent to each other and supported by at least one substrate. The gas diffusion layer is composed of a teflonated carbon matrix. The teflonated carbon matrix may be comprised of 40-45% teflonated acetylene black carbon or 60% teflonated Vulcan XC-72 carbon (Trademark of Cabot Corp.). The active material layer of the cathode in accordance with the present invention is composed of carbon particles coated with PTFE. The carbon particles are preferably carbon black particles, such as Black Pearl 2000 (Trademark of Cabot Corp.). The carbon/PTFE black mixture contains approximately 10 to 25 percent PTFE with the remainder being carbon black particles. An active material catalytic toward the dissociation of molecular oxygen into atomic oxygen is dispersed throughout the active material layer. The active catalyst material may be selected from silver metal, silver alloys, silver oxide, cobalt oxide, cobalt manganese oxide, cobalt, nickel, manganese oxides, manganese dioxide, pyrolyzed macrocyclics, or combinations thereof. The active material layer may also include up to 30 weight percent of a peroxide decomposing material. The peroxide decomposing material may be selected from MnO₂, MnO, cobalt oxides, nickel oxides, silver oxides, iron oxides, or mixtures thereof.

The active catalyst material may be incorporated into the active material layer by mechanically mixing the active catalyst material with the teflonated carbon prior to forming the electrode, or the active catalyst material may be impregnated into the active material layer after formation of the electrode. To impregnate the active material layer of the cathode with the active catalyst material after electrode formation, the active catalyst material may be chemically or electrochemically impregnated into the active material layer. To chemically or catalytically impregnate the active material layer of the cathode, the cathode is first dipped into an aqueous/nonaqueous solution of an active catalyst material precursor. The cathode may be drip dried and subsequently dipped into a 10% by weight sugar solution which acts as a reducing agent. The active catalyst material precursor may be a 1M solution of the active catalyst material, however, the molarity of the solution may be varied as needed to increase or decrease the amount of catalyst deposited within the cathode. Other precursors such as a AgNO₃/Ga(NO)₃ mixture, AgNO₃/LiNO₃ mixture, Co(NO₃)₂, a cobalt amine complex, NI(NO₃)₂, Mn(NO₃)₂, cyano complexes, organo metallic complexes, amino complexes, citrate/tartrate/lactate/oxalate complexes, transition metal complexes, transition metal macrocyclics, and mixtures thereof may be substituted for the AgNO₃ in the precursor solution. Once submerged in the aqueous active catalyst material precursor solution, the solution may be pulled into the active material layer under vacuum. The varying layers of hydrophobicity between the gas diffusion layer and the active material layer allow the solution to penetrate into the pores within the active material layer and not penetrate into the gas diffusion layer. This unique construction of multiple hydrophobicity in the electrode layers makes is possible to selectively deposit the catalyst only in the active material layer of the electrode. The active catalyst material is deposited from the aqueous solution in the pores within the active material layer and any air or gases present in the solution pass through the gas diffusion layer. In addition to dipping in the aqueous solution, the impregnation may be performed by spraying or spreading the active catalyst on the electrode surface. After removing the cathode from the active catalyst material solution, the cathode is dried at room temperature. The cathode is then heat treated at 50 degrees Celsius to remove any water from the electrode. The cathode may then be heat treated at 300-375 degrees Celsius for half an hour to decompose any remaining metal nitrates into their corresponding oxides. Temperatures exceeding this range are not employed because the teflon binder will begin to decompose and adversely affect the performance of the electrodes. Depending upon the catalyst used, these oxides may further decompose to produce their parent metal catalysts. To add more catalyst the above process is repeated as necessary. The cathode is then cooled and ready for use. After impregnation, the active catalyst material forms submicron to nano particles of the active catalyst material within the carbon matrix.

The anodes and cathodes in accordance with the present invention may be paste-type electrodes or non paste-type electrodes. Non-paste type electrodes may be powder compacted, sintered chemically/electrochemically impregnated, or plastic bonded extruded type. Paste-type electrodes may be formed by applying a paste of the active electrode material onto a conductive substrate, compressing a powdered active electrode material onto a conductive substrate, or by forming a ribbon of the active electrode material and affixing it onto a conductive substrate.

The substrate as used in accordance with the present invention may be any electrically conductive support structure that can be used to hold the active composition. Such substrates may be selected from, but not limited to, an electrically conductive mesh, grid, foam, expanded metal, or combinations thereof. The substrate may be comprised of nickel, steel, titanium, graphite, copper, or other suitable materials. A preferable substrate is an electrically conductive mesh having 40 wires per inch horizontally and 20 wires per inch vertically, although other meshes may work equally well. The wires comprising the mesh may have a diameter between 0.005 inches and 0.01 inches, preferably between 0.005 inches and 0.008 inches. This design provides optimal current distribution due to the reduction of the ohmic resistance. Where more than 20 wires per inch are vertically positioned, problems may be encountered when affixing the active material to the substrate. The conductive substrate may be formed of any electrically conductive material and is preferably formed of a metallic material such as a pure metal or a metal alloy. Examples of materials that may be used include nickel, nickel alloy, copper, copper alloy, nickel-plated metals such as nickel-plated copper and copper-plated nickel.

In a paste type electrode, the active electrode composition is first made into a paste. This may be done by first making the active electrode composition into a paste, and then applying the paste onto a conductive substrate. A paste may be formed by adding water and a “thickener” such as carboxymethyl cellulose (CMC) or hydroxypropylmethyl cellulose (HPMC) to the active composition. The paste would then be applied to the substrate. After the paste is applied to the substrate to form the electrode, the electrode may be sintered. The electrode may optionally be compressed prior to sintering.

To form the electrodes by compressing the powdered active electrode material onto the substrate, the active electrode material is first ground together to form a powder. The powdered active electrode material is then pressed or compacted onto a conductive substrate. After compressing the powdered active electrode material onto the substrate, the electrode may be sintered. To form the electrodes using ribbons of the active electrode material, the active electrode material is first is ground into a powder and placed into a roll mill. The roll mill preferably produces a ribbon of the active electrode material having a thickness ranging from 0.018 to 0.02 inches, however, ribbons with other thicknesses may be produced in accordance with the present invention. Once the ribbon of the active electrode material has been produced, the ribbon is placed onto a conductive substrate and rerolled in the roll mill to form the electrode. After being rerolled, the electrode may be sintered. The electrode may be sintered in the range of 170 to 180° C. where a conductive polymer is included so as not to decompose the conductive polymer, however, where a conductive polymer is not included, the electrode may be sintered in the range of 310 to 330° C. The sintering time will be adjusted for the chosen temperature. As a rule of thumb, lower sintering temperatures require longer sintering times, and vice versa.

The oxygen evolution electrode as used in the electrolytic cell portions of the present invention comprises a substrate. The substrate may be comprised of nickel, steel, titanium, graphite, copper, or other suitable materials, however, nickel is preferred. The substrate may be in sheet, expanded metal, metal foam, wire, or screen configurations. A catalytic material, which is catalytic toward the oxygen evolution reaction in water electrolysis, may be deposited on the substrate to enhance the performance of the oxygen evolution electrode. The catalytic material used in the oxygen evolution electrode is generally comprised of a host matrix with one or more modifier elements disposed therein. Such a catalytic material is disclosed in U.S. Pat. No. 4,537,674 to Ovshinsky et al., the disclosure of which is hereby incorporated by reference. The host matrix of the catalytic material may include at least one transition element, preferably Co, Ni, or Mn, which is structurally modified by incorporating one or more modifier elements, one of which may also be a transition element. The modifier elements may be chosen from Co, Ni, Sr, Li, In, K, Sn, C, O, Mn, Ru, and Al. A TiRu oxide may also be used as the catalytic material for the oxygen evolution electrode. The catalytic material may also include leachable elements like aluminum or zinc which are subsequently partially leached out of the catalytic material to leave a layer of a higher surface to volume ratio, which increases the catalytic activity of the material. The inclusion of the modifier elements improves the catalytic activity of the catalytic material by structurally modifying the local chemical environments of the host matrix to provide a catalytic material having an increased density of catalytically active sites. The substrate may be in forms chosen from sheet, expanded metal, wire, or screen.

The oxygen evolution electrode is formed by depositing the catalytic material onto the substrate. The catalytic material may be deposited by any of the thin film vacuum deposition techniques (i.e., sputtering, vapor deposition, plasma deposition, or spraying). Cosputtering is a particularly useful method for forming the depositing the catalytic material onto the substrate because it facilitates modification of the host matrix on the atomic scale, thus enabling tailor-making of the material and also allowing for the formation of an intimate mixture of the material's component elements.

The foregoing is provided for purposes of explaining and disclosing preferred embodiments of the present invention. Modifications and adaptations to the described embodiments, particularly involving changes to the shape of the fuel cell and components thereof and varying electrode compositions will be apparent to those skilled in the art. These changes and others may be made without departing from the scope or spirit of the invention in the following claims.

1. A hybrid fuel cell comprising:
a fuel cell portion; and
an electrolytic cell portion;
said fuel cell portion and said electrolytic cell portion being adapted to operate alone or in tandem.

2. The hybrid fuel cell according to claim 1, wherein said hybrid fuel cell further comprises an anode section including one or more anodes.

3. The hybrid fuel cell according to claim 2, wherein said anode section is shared between said fuel cell portion and said electrolytic cell portion.

6. The hybrid fuel cell according to claim 2, wherein said anode comprises a hydrogen storage material and/or Raney nickel.

7. The hybrid fuel cell according to claim 6, wherein said anode comprises 0.0 to 88.0 weight percent of said hydrogen storage material, 0.0 to 88.0 weight percent Raney nickel, 4.0 to 12.0 weight percent of a binder material, and 0.0 to 5.0 weight percent of a conductive material.

8. The hybrid fuel cell according to claim 7, wherein said conductive material comprises graphite or graphitized carbon.

9. The hybrid fuel cell according to claim 7, wherein said hydrogen storage material comprises Rare-earth metal alloys, Misch metal alloys, zirconium alloys, titanium alloys, magnesium/nickel alloys, or mixtures thereof.

10. The hybrid fuel cell according to claim 2, wherein said fuel cell portion comprises at least one cathode, said cathode being in electrical communication with said anode section.

11. The hybrid fuel cell according to claim 10, wherein said cathode comprises a carbon matrix with an active catalyst material catalytic toward the dissociation of molecular oxygen dispersed therein.

12. The hybrid fuel cell according to claim 11, wherein said active catalyst material is selected from silver, silver alloys, silver oxide, cobalt, cobalt oxide, cobalt manganese oxide, nickel, manganese oxide, manganese dioxide, pyrolyzed macrocyclics, or combinations thereof.

13. The hybrid fuel cell according to claim 11, wherein said cathode further comprises a peroxide decomposing material.

14. The hybrid fuel cell according to claim 2, wherein said electrolytic cell portion comprises at least one oxygen evolution electrode, said oxygen evolution electrode being in electrical communication with said anode section.

15. The hybrid fuel cell according to claim 14, wherein said oxygen evolution electrode comprises an electrocatalytic material deposited on a substrate.

16. The hybrid fuel cell according to claim 15, wherein said electrocatalytic material comprises a host matrix and at least one modifier element disposed therein.

17. The hybrid fuel cell according to claim 16, wherein said host matrix comprises at least one transition metal element.

18. The hybrid fuel cell according to claim 16, wherein said at least one modifier element is selected from Co, Ni, Sr, Li, K, In, Sn, C, Mn, Ru, Zn, Al, and combinations thereof.

19. The hybrid fuel cell according to claim 15, wherein said electrocatalytic material comprises Ti and Ru.

20. The hybrid fuel cell according to claim 15, wherein said electrocatalytic material is deposited on said substrate via sputtering, vapor deposition, electro-deposition, thermal spraying, plasma deposition, or spraying.

21. The hybrid fuel cell according to claim 14, wherein said oxygen evolution electrode comprises a conductive material selected from nickel, steel, titanium, graphite, copper, and combinations thereof.

22. The hybrid fuel cell according to claim 21, wherein said conductive material is the form of an electrically conductive mesh, a grid, a foam, an expanded metal, or combinations thereof.

23. The hybrid fuel cell according to claim 1, wherein said electrolytic cell portion is adapted to accept an electrical current from a source of power external to said hybrid fuel cell.

24. The hybrid fuel cell according to claim 1, wherein said fuel cell portion and said electrolytic cell portion share an electrolyte.

25. The hybrid fuel cell according to claim 1 further comprising a hydrogen storage unit adapted to store hydrogen produced from said electrolytic cell portion in gaseous, liquid, or metal hydride form.

26. The hybrid fuel cell according to claim 1 further comprising an oxygen storage unit adapted to store oxygen from said electrolytic cell portion in gaseous, liquid, or oxide form.
